(19) United States
(12) Patent Application Publication
(10) Pub. No.: US 2026/0134418 A1
(43) Pub. Date: May 14, 2026

(54) SYSTEMS AND METHODS FOR SECURELY PROVISIONING LIMITED ACCOUNT ACCESS

(71) Applicant: Wells Fargo Bank, N.A., San Francisco, CA (US)

(72) Inventors: John Andrew Chuprevich, Davidson, NC (US); Matthew N. Wheeler, Charlotte, NC (US)

(21) Appl. No.: 18/947,373

(22) Filed: Nov. 14, 2024

(51) Int. Cl. G06Q 20/38; G06Q 20/20

(52) U.S. Cl. CPC G06Q 20/3821; G06Q 20/206

(57) ABSTRACT

Systems, apparatuses, methods, and computer program products are disclosed for provisioning limited user account access. An example method includes receiving a provisioning request from a user device associated with a provisioning user, wherein the provisioning request comprises an authorized fund amount. The example method further includes performing a limited account access provisioning routine in response to receipt of the provisioning request by determining an access parameter set for a provisioning event associated with a user account associated with the provisioning user and causing generation of a redeemable authentication credential. The example method further includes generating a rule set for the provisioning event to reflect the access parameter set and providing the redeemable authentication credential to the user device.

### BACKGROUND

Traditional fund transfers have used digital peer-to-peer (P2P) payment applications. These applications require both parties to have direct access to the same payment application. This may make P2P payments less desirable or even impractical for some.

### BRIEF SUMMARY

As described above, current methods for P2P payments may be facilitated over a wide variety of digital platforms. While current methods for digital transactions using P2P platforms may streamline fund exchanges and offer convenience, they suffer from various limitations. In particular, existing systems typically require both users to be registered on the same platform or payment service. This may create a barrier for cross-platform or unregistered users to participate in P2P payments. Additionally, P2P payments suffer from various security concerns that make these payments susceptible to fraud attempts. Furthermore, these existing systems provide a provisioning user with limited control over how, where, and when the funds can be redeemed by a designated user. The designated user traditionally has limited options to accept or reject a payment from the provisioning user. Thus, existing systems offer little flexibility over the manner of fund transfer for either party.

In contrast to these convention techniques for P2P transfers, example embodiments described herein remove the technological barriers imposed by traditional P2P platforms, provide enhanced security measures around the transfer, and enable both parties to control and dynamically manage parameters of the transfer. Thus, example embodiments described herein enable seamless, real-time fund transfers between a provisioning user and a designated user without the need for both parties to have access to the same payment platform while still ensuring security and fraud protection.

In particular, example embodiments allow a provisioning user to provide a provisioning request. The provisioning user may select and define individual values and/or options within the provisioning request to control how a designated user can redeem an authorized fund amount. In some embodiments, in order to provide the provisioning request, the provisioning user must log in to his/her associated user account. In some embodiments, the provisioning request may further be authenticated using a passkey associated with the user device that provided the provisioning request. The use of a passkey may provide enhanced security as compared to traditional authentication methods. In particular, passkeys are phishing resistant and are inherently invulnerable to several forms of password-based attacks. Thus, the identity of the provisioning user may be securely verified, which in turn allows the provisioning request to be authenticated and trusted as a legitimate request.

Upon receipt of the provisioning request, example embodiments may generate a provisioning event. The provisioning event may be associated with the user account of the provisioning user and may be used to store, connect, or otherwise aggregate data relating to the provisioning request. The provisioning event may include a rule set that includes one or more rules that define requirements, limits, values, conditions, and/or the like in order for a designated user to be provided with limited access to the user account (e.g., redeem an authorized fund amount from the user account).

Prior to generating the rule set, example embodiments may perform a limited account access provisioning routine. In some embodiments, during this routine, an access parameter set may be determined. The access parameter set may include access parameters that reflect the user input and/or selected values of the provisioning request. The rule set may be generated based on the access parameter set and thus, may implement these user input values as requirements, thus enforcing the limits desired by the provisioning user. In some example embodiments, prior to generating the rule set, an acceptance request may be provided directly or indirectly to a designated user. The acceptance request may allow the designated user to view the access parameters of the provisioning event and thus, the designated user may be made aware of the current requirements imposed by the provisioning request. The acceptance request may allow the designated user to accept, decline, or propose to modify the current access parameters. Thus, the designated user is also provided with enhanced control over the manner in which he/she may receive the authorized fund amount.

Additionally, during the limited account access provisioning routine, a redeemable authentication credential may be generated. The redeemable authentication credential may encode a provisioning event identifier. The provisioning event identifier may uniquely identify the particular provisioning event. Thus, the provisioning event may be identified by the provisioning identifier, which is securely encoded within the redeemable authentication credential. In some embodiments, the redeemable authentication credential may be provided to the provisioning user, who in turn, may provide it to the designated user. In some embodiments, the provisioning user may provide the redeemable authentication credential to the designated user through short-distance communication techniques, such as Bluetooth, near field communication (NFC), over Wi-Fi, etc. In some embodiments, the user device of the provisioning user may display the redeemable authentication credential, and the user device of the designated user may capture an image of the redeemable authentication credential. Thus, in some embodiments, the provisioning user and designated user may be required to be within proximity of one another to exchange information, thereby reducing various security vulnerabilities associated with traditional digital P2P platforms.

Once the designated user is in possession of the redeemable authentication credential, the designated user may use a redemption device to provide a redemption request. The redemption request may include a candidate redeemable authentication credential as provided by the designated user. In some embodiments, the candidate redeemable authentication credential may be decoded to identify the provisioning event identifier, which in turn may be used to identify the provisioning event. The redemption request may be evaluated to determine whether it satisfies the rule set associated with the provisioning event. The designated user may be provided limited access to the user account such that the authorized fund amount is redeemable by the designated user. Advantageously, the designated user may not be required to log in to his/her user account to redeem the authorized fund amount unless so required by the rule set of the provisioning event. Thus, example embodiments described herein provide for a secure, robust, and flexible means of transferring funds between users without requiring the users to use a particular digital platform. This may be particularly beneficial for disadvantaged users, such as users who are unbanked or underbanked, by providing these users with the means to participate in the digital payments without the need for a formal banking relationship.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used to provision limited account redemption access.

FIG. 2 illustrates a schematic block diagram of example circuitry embodying a system device that may perform various operations in accordance with some example embodiments described herein.

FIG. 3 illustrates an example flowchart for handling provisioning request from a user device, in accordance with some example embodiments described herein.

FIG. 4 illustrates an example flowchart for authenticating a provisioning request using a passkey, in accordance with some example embodiments described herein.

FIG. 5 illustrates an example flowchart for performing a limited account access provisioning routine, in accordance with some example embodiments described herein.

FIG. 6 illustrates an example flowchart for handling a redemption request from a redemption device, in accordance with some example embodiments described herein.

FIG. 7 illustrates an example flowchart for handling a recission request, in accordance with some example embodiments described herein.

FIG. 8 illustrates an example flowchart for handling a milestone completion notification, in accordance with some example embodiments described herein.

FIGS. 9A and 9B illustrates example user interfaces for an account redemption access tool that may be used to provide a provisioning request, in accordance some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

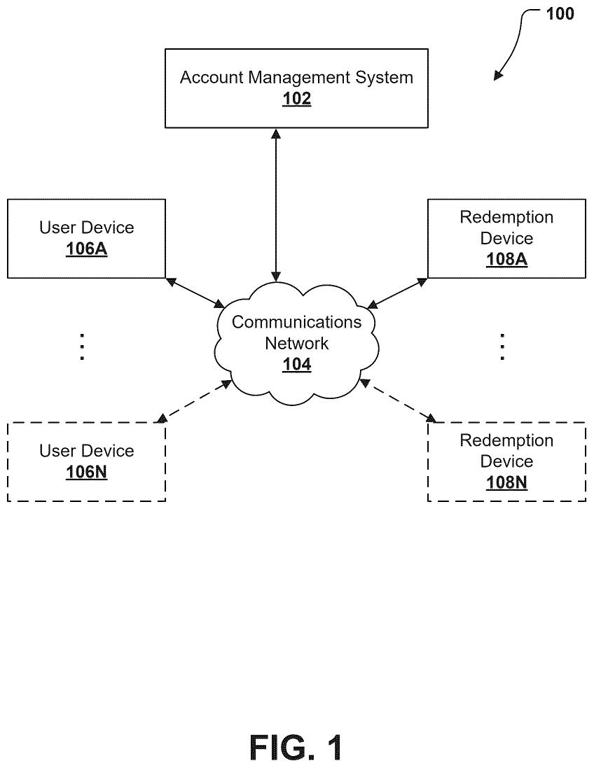

Example embodiments described herein may be implemented using any of a variety of computing devices or servers. To this end, FIG. 1 illustrates an example environment 100 within which various embodiments may operate. As illustrated, an account management system 102 may receive and/or transmit information via communications network 104 (e.g., the Internet) with any number of other devices, such as one or more of user devices 106A-106N and/or redemption devices 108A-108N.

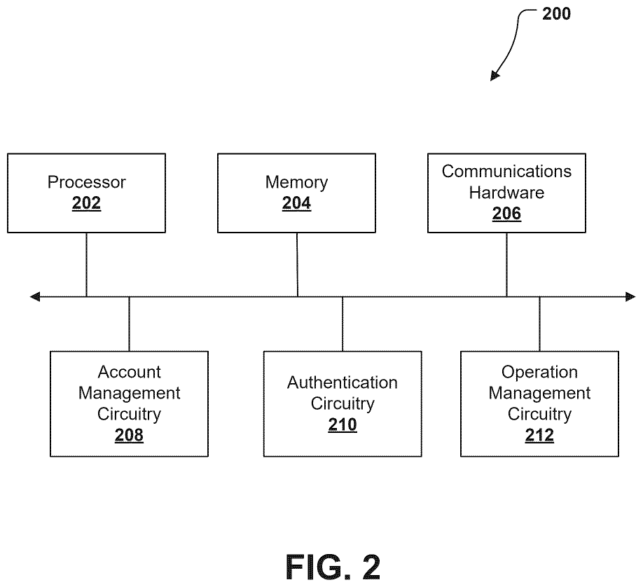

The account management system 102 may be implemented as one or more computing devices or servers, which may be composed of a series of components. Particular components of the account management system 102 are described in greater detail below with reference to apparatus 200 in connection with FIG. 2.

In some embodiments, the account management system 102 further includes a storage device that comprises a distinct component from other components of the account management system 102. The storage device may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). The storage device may host the software executed to operate the account management system 102. The storage device may store information relied upon during operation of the account management system 102, such as data and documents to be analyzed using the account management system 102 or the like. In addition, the storage device may store control signals, device characteristics, and access credentials enabling interaction between the account management system 102 and one or more of the user devices 106A-106N and/or redemption devices 108A-108N.

The one or more user devices 106A-106N and the one or more redemption devices 108A-108N may be embodied by any computing devices known in the art. The one or more user devices 106A-106N and the one or more redemption devices 108A-108N need not themselves be independent devices but may be peripheral devices communicatively coupled to other computing devices. In some embodiments, a user device (e.g., any one of user devices 106A-106N) may be associated with a provisioning user who is associated with a user account maintained by the account management system 102 (e.g., a customer). In some embodiments, a user device (e.g., any one of user devices 106A-106N) may be associated with a designated user who may be provided limited account access to the provisioning user's user account. The designated user may also have a user account maintained by the account management system 102 (e.g., a customer). However, the designated user may not have a user account maintained by the account management system 102 (e.g., a customer). In some embodiments, a redemption device (e.g., any one of agent devices 108A-108N) may be a device associated with the account management system 102. In some embodiments, the redemption device (e.g., any one of redemption devices 108A-108N) may be an automated teller machine (ATM). In some embodiments, the redemption device (e.g., any one of redemption devices 108A-108N) may be associated with an agent that is affiliated with account management system 102 (e.g., a bank teller who is an employee of an entity that operates account management system 102).

Although FIG. 1 illustrates an environment and implementation in which the account management system 102 interacts indirectly with a user via one or more of user devices 106A-106N and/or redemption devices 108A-108N, in some embodiments users may directly interact with the account management system 102 (e.g., via communications hardware of the account management system 102), in which case a separate user device 106A-106N and/or redemption device 108A-108N may not be utilized. Whether by way of direct interaction or indirect interaction via another device, a user may communicate with, operate, control, modify, or otherwise interact with the account management system 102 to perform the various functions and achieve the various benefits described herein.

### Example Implementing Apparatuses

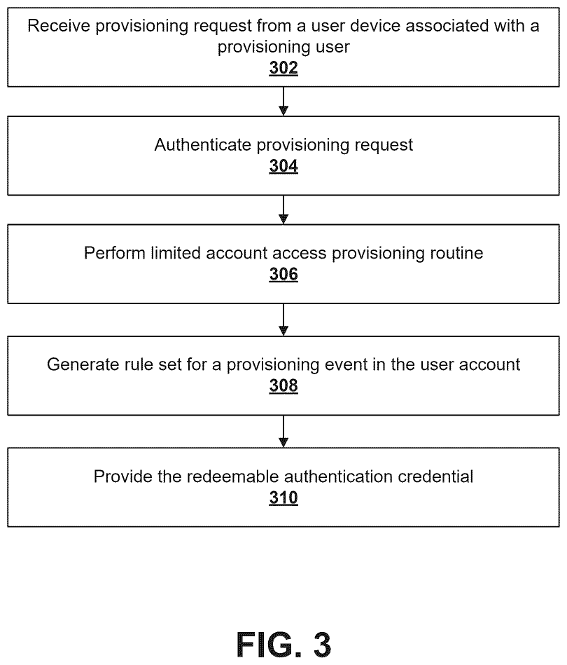

The account management system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3-8. As illustrated in FIG. 2, the apparatus 200 may include processor 202, memory 204, communications hardware 206, account management circuitry 208, authentication circuitry 210, operation management circuitry 212, each of which will be described in greater detail below.

The processor 202 (and/or co-processor or any other processor assisting or otherwise associated with the processor) may be in communication with the memory 204 via a bus for passing information amongst components of the apparatus 200. The processor 202 may be embodied in a number of different ways and may, for example, include one or more processing devices configured to perform independently. Furthermore, the processor 202 may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor 202. In some cases, the processor 202 may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, software application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises account management circuitry 208 that may be configured to perform a limited account access provisioning routine, determine an access parameter set, generate a rule set, determine a redemption result for a redemption request, authorize or deny a redemption request, determine whether a rule set allows for a recission of authorization to transfer the authorized fund amount, update a rule set, and/or the like. The account management circuitry 208 may utilize processor 202, memory 204, or any other hardware component included in the apparatus 200 to perform these operations, as described in connection with FIGS. 3-8 below. The account management circuitry 208 may further utilize communications hardware 206 to gather data from a variety of sources (e.g., any one of user devices 106A-106N or redemption devices 108A-108N, as shown in FIG. 1), and/or exchange data with a provisioning user and/or designated user.

In addition, the apparatus 200 further comprises authentication circuitry 210 that may be configured to generate a redeemable authentication credential, generate a passkey challenge, authenticate a signed passkey challenge, identify a provisioning event, and/or the like. The authentication circuitry 210 may utilize processor 202, memory 204, or any other hardware component included in the apparatus 200 to perform these operations, as described in connection with FIGS. 3-8 below. The authentication circuitry 210 may further utilize communications hardware 206 to gather data from a variety of sources (e.g., any one of user devices 106A-106N or redemption devices 108A-108N, as shown in FIG. 1), and/or exchange data with a provisioning user and/or designated user.

Further, the apparatus 200 further comprises operation management circuitry 212 that may be configured to provide a designated user with limited access to the user account of the provisioning user, cause the authorized fund amount to be transferred from the user account of the provisioning user to the user account of the designated user, cause the authorized fund amount to be dispensed by the redemption device, and/or the like. The operation management circuitry 212 may utilize processor 202, memory 204, or any other hardware component included in the apparatus 200 to perform these operations, as described in connection with FIGS. 3-8 below. The operation management circuitry 212 may further utilize communications hardware 206 to gather data from a variety of sources (e.g., any one of user devices 106A-106N or redemption devices 108A-108N, as shown in FIG. 1), and/or exchange data with a provisioning user and/or designated user.

Although components 202-212 are described in part using functional language, it will be understood that the particular implementations necessarily include the use of particular hardware. It should also be understood that certain of these components 202-212 may include similar or common hardware. For example, the account management circuitry 208, authentication circuitry 210, and operation management circuitry 212 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the account management circuitry 208, authentication circuitry 210, and operation management circuitry 212 may leverage processor 202, memory 204, or communications hardware 206 as described above, it will be understood that any of account management circuitry 208, authentication circuitry 210, and operation management circuitry 212 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that account management circuitry 208, authentication circuitry 210, and operation management circuitry 212 comprise particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third-party circuitry. For example, a given apparatus 200 may access one or more third-party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatus 200, example embodiments are described below in connection with a series of graphical user interfaces and flowcharts.

### Example Operations

Turning to FIGS. 3-8, example flowcharts are illustrated that contain example operations implemented by example embodiments described herein. The operations illustrated in FIGS. 3-8 may, for example, be performed by the account management system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, account management circuitry 208, authentication circuitry 210, operation management circuitry 212, and/or any combination thereof. It will be understood that user interaction with the account management system 102 may occur directly via communications hardware 206, or may instead be facilitated by a separate user device (e.g., any one of user device 106A-106N) and/or a redemption device (e.g., any one of redemption devices 108A-108N), as shown in FIG. 1, and which may have similar or equivalent physical componentry facilitating such user interaction.

Turning first to FIG. 3, example operations are shown for handling a provisioning request. As described in further detail below, a provisioning request may be indicative that a provisioning user wishes to enable another user (e.g., a designated user) to access funds from his/her user account. The provisioning user may set access parameters in the provisioning request to control to control and set limits on user account access provided to the designated user. Prior to performing a limited account access provisioning routine, apparatus 200 may also authenticate the provisioning request. In some embodiments, this may require the provisioning user to use a passkey to sign a digital challenge. Thus, apparatus 200 may ensure the provisioning request was received from the provisioning user and not a fraudster. The use of a passkey provides for a more secure method of authentication as compared to traditional techniques that may be vulnerable to password stealing, biometric credential spoofing, and various phishing scams. In addition to this enhanced security, the use of a passkey for authentication may provide for streamlined authentication that requires little to no manual effort on the part of the provisioning user. Once the provisioning request is successfully authenticated, a limited account access provisioning routine may be performed, and a redeemable authentication credential may be generated and provided to the user device. The user device can then provide this to a user device of a designated user. This process may be performed in real-time or near real-time, thus ensuring that a designated user is provided with the redeemable authentication credential in a time efficient manner. This may be particularly important as the interaction between the provisioning user and designated user may be time sensitive.

As shown by operation 302, the apparatus 200 includes means, such as memory 204, communications hardware 206, account management circuitry 208, authentication circuitry 210, or the like, for receiving a provisioning request from a user device associated with a provisioning user. Communications hardware 206 may receive the provisioning request from a user device, such as user device 106A. The user device 106A may be associated with a provisioning user. In some embodiments, the provisioning request may include an authorized fund amount, a time limit that controls the duration for which the redeemable authentication credential is valid, an indication of whether the redeemable authentication credential is revocable or irrevocable, one or more authorized redemption locations and/or redemption devices, an indication of a designated user, and/or the like. These values may be manually input and selected by the provisioning user, thus providing the provisioning user with tailored control over the access the designated user has to his/her user account.

In some embodiments, the provisioning user may be required to log in to his/her user account using an online browser or software application, such as a mobile application, using user device 106A. To log in to a user account, the provisioning user may provide candidate user credentials (e.g., a username, phone number, email address, and/or the like) and, in some embodiments, may select a method of authentication. Depending on the method of authentication, the user may provide candidate authentication credentials. Candidate authentication credentials may include a one-time passcode, a password, a PIN, biometric data, and/or the like. The authentication circuitry 210 may determine whether the log in request is valid based on the candidate authentication credentials. For example, the authentication circuitry 210 may determine whether the provided candidate authentication credentials correspond to stored authentication credentials that are associated with the user account indicated by the candidate user credentials. If the candidate authentication credentials match the stored authentication credentials, the authentication circuitry 210 may successfully authenticate the log in request and user data for the user account may be shared with the user device 106A.

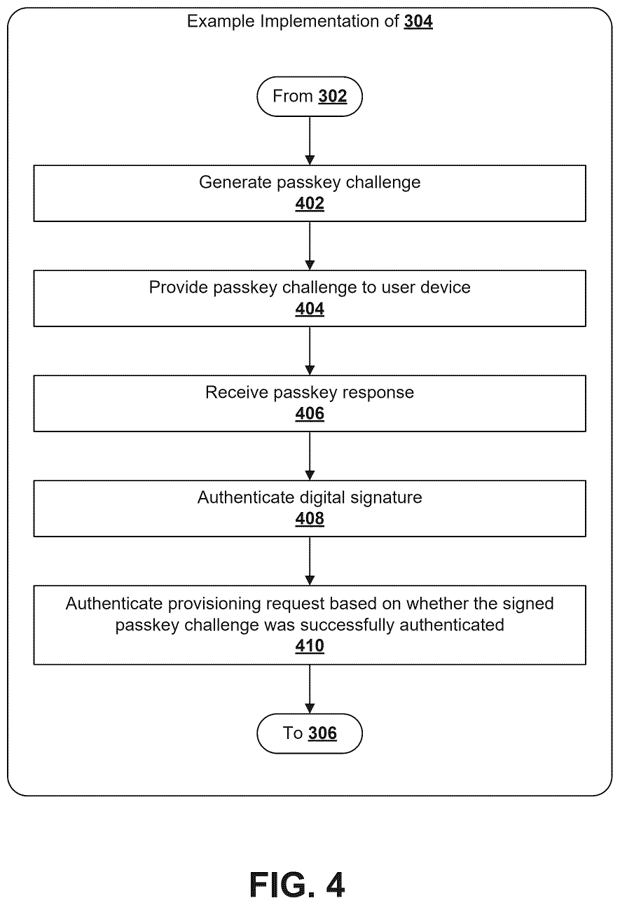

In some embodiments, the user may select to log in to a user account using a passkey. The particular operations for authenticating a log in request using a passkey may be substantially similar to the authentication process for authenticating a provisioning request, which is described in more detail in FIG. 4.

Once the log in request is successfully authenticated, the user device 106A may establish a secure session with communications hardware 206. During the secure session, the provisioning user may access user data from his/her user account and performed account operations for the user account. The communications hardware 206 may receive a provisioning request from the user device 106A during such an established secure session. Thus, in some embodiments, the provisioning request is received by the communications hardware 206 after the user has successfully logged into his/her user account via user device 106A.

Upon receipt of the provisioning request, the account management circuitry 208 may generate a provisioning event. The provisioning event may be a structured data object that is configured to store, link, or otherwise associate data with the provisioning request. The account management circuitry 208 may store the provisioning event in an associated memory, such as memory 204. Furthermore, the provisioning event may be stored in the user account of the provisioning user or may be otherwise associated with or linked to the user account of the provisioning user. In some embodiments, the provisioning request and/or data from the provisioning request may be stored in associated with the provisioning event. In some embodiments, the provisioning event may be associated with a redemption status. The redemption status may be indicative of whether the authorized fund amount has been redeemed by a designated user. For example, a status of the provisioning event may be “available” initially and “redeemed” once the authorized fund amount has been redeemed by the designated user.

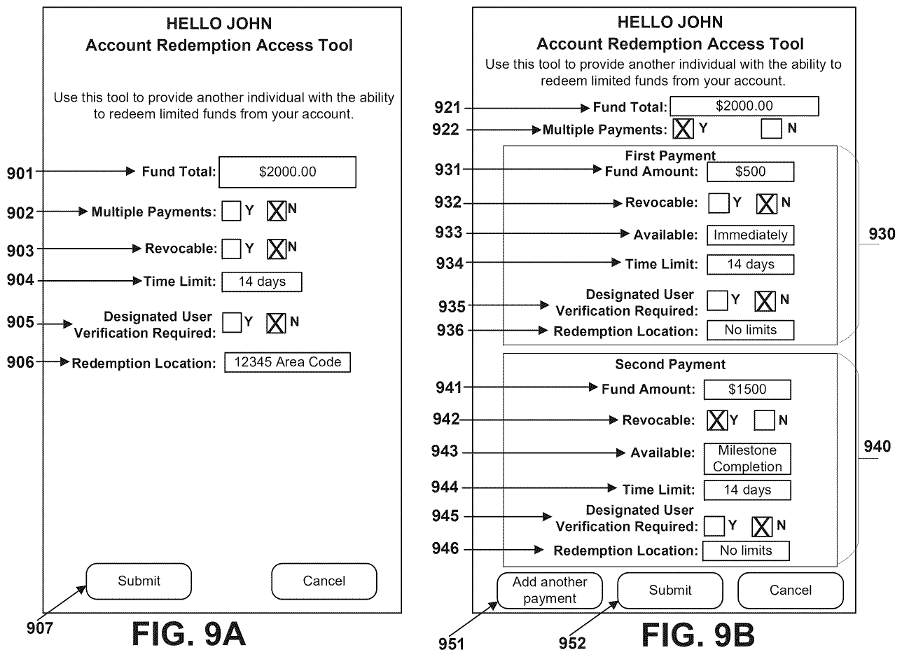

Turning to FIG. 9A, a graphical user interface (GUI) is provided that illustrates an example provisioning request. As noted previously, a user may interact with apparatus 200 by directly engaging with communications hardware 206. Alternatively, a user may interact with the apparatus 200 using a separate user device (e.g., any of user device 106A-106N, as shown in FIG. 1). In such an embodiment, the GUI shown in FIG. 9A may be displayed to the user by the user device, such as user device 106A.

As shown in FIG. 9A, the user may input values and/or selections for various access parameter fields 901-906. In some embodiments, the provisioning request may allow the user to input freeform text and/or select a predefined category or value for each access parameter field. As shown in FIG. 9A, a provisioning user may input a value of $2000.00 for the fund total access parameter field 901 within the provisioning request. The user may have additionally selected that the payment is not revocable for the revocable access parameter field 903, input a value of 14 days for the time limit access parameter field 904, selected that the designated user is not required for the designated user verification access parameter field 905, and input a redemption location of an authorized redeeming location in the 12345 area code for a redemption location access parameter field 906. Additionally, the provisioning request may indicate that the user selected only a single payment for the multiple payment request parameter 902. The communications hardware 206 may receive the provisioning request from the user device 106A in response to the user interacting with the submit interaction element 907.

As shown by operation 304, the apparatus 200 includes means, such as authentication circuitry 210, or the like, for authenticating the provisioning request. In some embodiments, prior to performing the limited account access provisioning routine, authentication circuitry 210 may be required to authenticate the provisioning request received from user device 106A. By authenticating the provisioning request, the authentication circuitry 210 verifies the identity of the provisioning user and thus, ensures that the user account of the provisioning user is kept secure.

In some embodiments, the authentication circuitry 210 may determine the provisioning request is successfully authenticated based on the method the user used for authentication to log in to the user account to submit the provisioning request. For example, if the user device 106A used a passkey for authentication to log into user account via a software application, the authentication circuitry 210 may determine the provisioning request has been successfully authenticated. In some embodiments, if the user device 106A used an authentication method other than passkey authentication to log into a user account, such as by using a password, biometric, PIN, or one-time passcode (OTP), the authentication circuitry 210 may determine the provisioning request is not authenticated yet.

In some embodiments, the authentication circuitry 210 may authenticate the provisioning request using a passkey associated with the user account of the provisioning user. In some embodiments, the provisioning user may have registered, enrolled, or otherwise configured his/her user account with a passkey. A passkey may include public-private cryptographic key pair. The private cryptographic key of the passkey is stored on a user device, such as user device 106A, and a corresponding public cryptographic key of the passkey is stored by apparatus 200, such as in memory 204 or a key management database, and in association with the user account of the provisioning user. As described in further detail in FIG. 4, the passkey for the provisioning user may be used to authenticate the provisioning request.

If the authentication circuitry 210 successfully authenticates the provisioning request, the process may proceed to operation 306. However, if the authentication circuitry 210 fails to authenticate the provisioning request, the process may terminate, and the subsequent operations of FIG. 3 are not performed. This ensures the limited account access to the user account of the provisioning user is only provided if the provisioning user identity can be successfully authenticated. Additionally, the authentication result may be stored in or associated with the provisioning event.

In some embodiments, operation 304 may be performed in accordance with the operations described by FIG. 4. Turning now to FIG. 4, example operations are shown for authenticating a provisioning request using a passkey.

As shown by operation 402, the apparatus 200 includes means, such as memory 204, authentication circuitry 210, or the like, for generating a passkey challenge. In some embodiments, authentication circuitry 210 may generate the passkey challenge in response to receiving the provisioning request from the user device. The passkey challenge may expire after a predetermined amount of time (e.g., ninety seconds, two minutes, or the like). The authentication circuitry 210 may use any suitable method (e.g., a random bit or number generator) to generate the passkey challenge. In some embodiments, the passkey challenge is a nonce value. The authentication circuitry 210 may generate the passkey challenge using any suitable algorithm, such as a random or pseudo-random number generator (e.g., a 128-bit or 256-bit number generator).

In some embodiments, the passkey challenge may be generated based on a set of passkey generation rules that are determined by the entity associated with account management system 102. For example, the passkey generation rules may require authentication circuitry 210 to generate a passkey challenge that satisfies a predetermined complexity (e.g., nonce length) to ensure that the passkey challenge is resistant to brute force attacks. Moreover, the use of a nonce the randomness injected into the passkey challenge by utilizing a nonce ensures that each passkey authentication challenge is unique, and thus cannot be reused in future authentication challenges. In some embodiments, the authentication circuitry 210 may generate the passkey challenge so that the passkey challenge is associated with a timestamp. This may allow the authentication circuitry 210 to enforce a predetermined amount of time (e.g., included in the passkey gene rules) that the passkey authentication challenge is valid.

In some embodiments, upon generating the passkey challenge, the authentication circuitry 210 may store the generated passkey challenge in a local storage device, such as in memory 204. For example, authentication circuitry 210 may store the passkey challenge in a user profile associated with the provisioning user indicated in the provisioning request. Upon determining the user and/or user profile to which the provisioning request corresponds, authentication circuitry 210 may store the generated passkey challenge with the timestamp and/or a valid time window in the identified user profile.

As shown by operation 404, the apparatus 200 includes means, such as communications hardware 206, authentication circuitry 210, or the like, for providing the passkey challenge to the user device. In some embodiments, the authentication circuitry 210 may cause the communications hardware 206 to provide the passkey challenge to user device 106A (e.g., the user device that provided the provisioning request) via a network (e.g., communications network 104, shown in FIG. 1). The communications hardware 206 may request the user device 106A to digitally sign the passkey challenge using its corresponding private cryptographic key and provide the digitally signed passkey challenge in a passkey response. Additionally, or alternatively, the passkey challenge may include instructions for the user device 106 to digitally sign the passkey challenge and provide the passkey response.

As shown by operation 406, the apparatus 200 includes means, such as communications hardware 206, authentication circuitry 210, or the like, for receiving a passkey response from the user device. The passkey response may refer to a cryptographic proof that may be subsequently used (e.g., in relation to operation 408) to verify that the user device 106A is in possession of a private cryptographic key that corresponds to a public cryptographic key of a passkey that is stored in a user profile associated with the provisioning user. The communications hardware 206 may receive a passkey response from user device 106A. In various embodiments, the user device 106A may sign the challenge using the private cryptographic key of the passkey to produce a digital signature. The passkey response may include this digital signature from the user device 106A. In this regard, the passkey response may a version of the passkey challenge that was transformed by user device 106A using a private cryptographic key that may be locally stored by user device 106A.

As shown by operation 408, the apparatus 200 includes means, such as authentication circuitry 210 or the like, for authenticating the digital signature. The authentication circuitry 210 may authenticate the digital signature included in the passkey response. In some embodiments, the authentication circuitry 210 uses the public cryptographic key of the passkey to authenticate the digital signature. In particular, the authentication circuitry 210 may check the validity of the digital signature using the public cryptographic key of the passkey associated with the provisioning user or user device. This allows the authentication circuitry 210 to verify whether user device 106A is in possession of the private cryptographic key of the passkey, which in turn, also serves as proof of the user identity.

In some embodiments, the authentication circuitry 210 may authenticate the signed challenge if the signature corresponds to the public cryptographic key stored in the memory 204 of the apparatus 200, and the authentication of the signed challenge may allow for the provisioning request to be authenticated. In some embodiments, if the signed challenge does not correspond to the public cryptographic key, the authentication circuitry 210 may reject the challenge and the provisioning request may not be authenticated. The authentication circuitry 210 may perform a cryptographic verification to determine whether the digital signature correctly corresponds to the original challenge. In some embodiments, the authentication circuitry 210 may access the original signature from the memory 204. If the digital signature corresponds to the original challenge, the authentication circuitry 210 may determine the digital signature is successfully authenticated. If the digital signature fails to correspond to the original challenge, the authentication circuitry 210 may determine the digital signature has failed authentication.

In some embodiments, the authentication circuitry 210 may determine the challenge response was received within a threshold time window. The authentication circuitry 210 may use the timestamp associated with the generation of the passkey challenge and a timestamp associated with the received passkey response to determine whether the passkey response was received within the threshold time window. If no challenge response is received within the threshold time window, the authentication circuitry 210 may determine the digital signature has failed authentication.

As shown by operation 410, the apparatus 200 includes means, such as authentication circuitry 210 or the like, for authenticating the provisioning request based on whether the signed passkey challenge was successfully authenticated. As described above, the authentication circuitry 210 may successfully authenticate the provisioning request if the digital signature is successfully authenticated.

If the digital signature fails to be authenticated, the authentication circuitry 210 may fail to authenticate the provisioning request. In some embodiments, if the provisioning request fails to be authenticated, the authentication circuitry 210 may generate additional passkey challenges and use communications hardware 206 to provide the additional passkey challenges up to a threshold number of times (e.g., three times). If a digital signature from an additional passkey response is successfully authenticated, the provisioning request may be successfully authenticated. If none of the digital signatures from the additional passkey responses are authenticated, the authentication circuitry 210 may fail to authenticate the provisioning request.

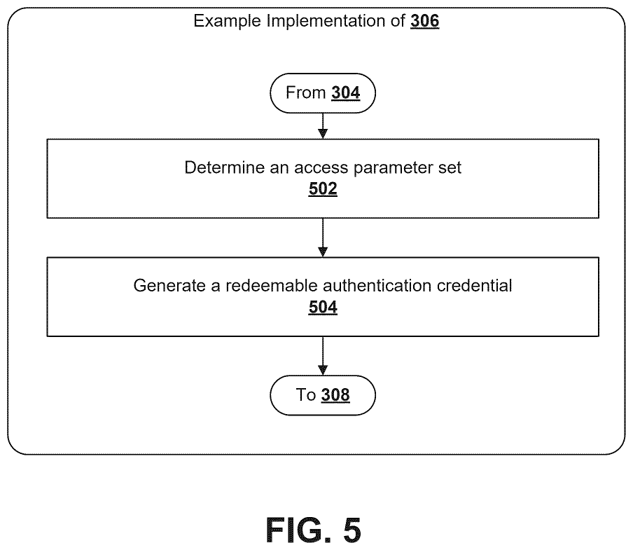

Returning now to FIG. 3, as shown by operation 306, the apparatus 200 includes means, such as account management circuitry 208, authentication circuitry 210, or the like, for performing a limited account access provisioning routine. Once the authentication circuitry 210 has successfully authenticated the provisioning request, the account management circuitry 208 may be configured to perform a limited account access provisioning routine. As further described in FIG. 5, the account management circuitry 208 may execute the limited account access provisioning routine and in turn, may determine an access parameter set that may be used to generate a rule set associated with the provisioning event that is associated with the user account. Additionally, the account management circuitry 208 may cause the authentication circuitry 210 to generate a redeemable authentication credential that may be used by a designated user to provide the designated user with limited access to the user account.

In some embodiments, operation 306 may be performed in accordance with the operations described by FIG. 5. Turning now to FIG. 5, example operations are shown for performing a limited account access provisioning routine.

As shown by operation 502, the apparatus 200 includes means, such as memory 204, account management circuitry 208, or the like, for determining an access parameter set. During the limited account access provisioning routine, the account management circuitry 208 may be configured to determine an access parameter set for the provisioning event. The account management circuitry 208 may determine the access parameter set based on the provisioning request. The access parameter set may include one or more access parameters that describe requirements, limits, values, conditions, and/or the in order for a designated user to be provided with limited access to the user account.

The account management circuitry 208 may determine the access parameter set based on the provisioning request. As described above, the provisioning request may include an authorized fund amount, a time limit that controls the duration for which the redeemable authentication credential is valid, an indication of whether the redeemable authentication credential is revocable or irrevocable, one or more authorized redemption locations and/or redemption devices, an indication of a designated user, and/or the like. In some embodiments, the provisioning request may further include an indication of whether an affirmative approval response must be received from the user device of the provisioning user prior to providing the designated user with limited access to the user account. These values may be manually input and selected by the provisioning user, thus providing the provisioning user with tailored control over the access the designated user has to his/her user account. The account management circuitry 208 may be configured to analyze the provisioning request to identify user selections and/or inputs and determine an access parameter. In some embodiments, the provisioning request may be structured such that the account management circuitry 208 is able to identify categorical access parameter fields and corresponding values from the provisioning request.

For example, referring back to FIG. 9A, in the provisioning request, the user may have input a value of $2000.00 for the fund total access parameter field, selected that the payment is not revocable for the revocable access parameter field, input a value of 14 days for the time limit access parameter field, selected that the designated user is not required for the designated user verification access parameter field, and input a redemption location of an authorized redemption location in the 12345 area code for a redemption location access parameter field. Additionally, the provisioning request may indicate that the user selected only a single payment for the multiple payment request parameter. Thus, the account management circuitry 208 may generate access parameters for each of an authorized fund amount access parameter, a multiple payment access parameter, a revocable payment access parameter, a time limit access parameter, a designated user verification requirement access parameter, and a redemption location access parameter.

By way of continuing example, the account management circuitry 208 may determine a value of $2000 for the authorized fund amount access parameter. The account management circuitry 208 may further determine a single payment category for the multiple payment access parameter. The account management circuitry 208 may further determine an irrevocable status for the revocable payment access parameter. The account management circuitry 208 may further determine a value of 14 days for a time limit access parameter. The account management circuitry 208 may further determine a “no verification required” category for the designated user verification requirement access parameter. The account management circuitry 208 may further determine a value of 12345 for the redemption location access parameter.

The account management circuitry 208 may include each determined parameter in the access parameter set and store the access parameter set in an associated memory, such as in memory 204. The access parameter set may be associated with the provisioning event.

In some embodiments, prior to proceeding to operation 504, the account management circuitry 208 may require the designated user to acknowledge and accept the limits, conditions, and/or requirements of the access parameter set. That is, the designated user must also agree to the limits and requirements set by the provisioning user in the provisioning request. In some embodiments, the account management circuitry 208 may cause communications hardware 206 to provide an acceptance request to user device 106A or to a user device, such as user device 106N, that is associated with the designated user. The acceptance request may include the access parameters for each access parameter field in the access parameter set. Thus, the designated user may view the limits and conditions of the provisioning request and can choose to accept or decline the current access parameters. In some embodiments, the acceptance request may allow the designated user to use user device 106N to modify one or more access parameters.

In some embodiments, the provisioning request may include an indication of the designated user and/or associated user device. In some embodiments, this indication may be a phone number associated with user device 106N. Thus, the account management circuitry 208 may determine whether an indication of the designated user is provided in the provisioning request and may use this information to identify the user device 106N. In some embodiments, the indication may be a username, email address, user identifier, or the like for the designated user. If the designated user also has a user account associated with apparatus 200, the account management circuitry 208 may use the indication of the designated user to identify the user account. The user device may list associated user devices of the designated user. Thus, the account management circuitry 208 may use the user account to identify user device 106N.

If the acceptance request is provided to the user device 106A, the user device 106A may provide the acceptance request to user device 106N. This may be accomplished through near-field communication (NFC), using Bluetooth, over Wi-Fi, and/or the like. Whether the communications hardware 206 provides the acceptance request to user device 106N directly or indirectly via user device 106A, user device 106N may provide an acceptance response. The acceptance response may be indicative of whether the designated user has accepted the access parameter set. If the designated user modified one or more access parameters, the account management circuitry 208 may cause the communications hardware 206 to provide an acceptance request to the provisioning user via user device 106A. The provisioning user may similarly accept or decline the modified access parameters or may modify the access parameters. If the provisioning user modifies the access parameters, the account management circuitry 208 may cause the communications hardware 206 to repeat the process and provide an acceptance request to the designated user via user device 106N. If both the provisioning user and designated user agree and accept the access parameters, the process may proceed to operation 504. However, if the provisioning user and designated user cannot agree and either party declines the access parameters, the process may terminate.

As shown by operation 504, the apparatus 200 includes means, such as memory 204, account management circuitry 208, authentication circuitry 210, or the like, for generating a redeemable authentication credential. In some embodiments, the account management circuitry 208 may cause the authentication circuitry 210 to generate a redeemable authentication credential during the limited account access provisioning routine. The redeemable authentication credential may be used by a designated user to redeem the authorized fund amount from the user account at a redemption device in the future.

The authentication circuitry 210 may generate the redeemable authentication credential using a random or pseudo-random number generating algorithm. In some embodiments, the authentication circuitry 210 may generate a random string of characters (e.g., numbers, letters, special characters or a combination thereof) to generate a unique provisioning event identifier. In some embodiments, the length of the provisioning event identifier may be between 128 to 256 bits. The provisioning event identifier corresponding to the redeemable authentication credential may uniquely identify the provisioning event, and also thereby identify the user account of the provisioning user. The provisioning event may also be assigned to the provisioning event such that the provisioning event is associated with the corresponding provisioning event identifier.

In some embodiments, the authentication circuitry 210 may be configured to generate the redeemable authentication credential as a token or a QR code. In some embodiments, the provisioning request from the provisioning user may include a preference for the redeemable authentication credential. The authentication circuitry 210 may generate the redeemable authentication credential based on this preference. In some embodiments, if no preference is selected, the authentication circuitry 210 may be configured to generate the redeemable authentication credential based on a default setting. The default setting may be any one of a token or QR code.

In some embodiments, if the authentication circuitry 210 determines to generate the redeemable authentication credential as a token, the authentication circuitry 210 may use the provisioning event identifier to generate a token. Further, the authentication circuitry 210 may encode the provisioning event identifier to generate the token and ensure it can be securely transmitted to user devices, such as user device 106A. In some embodiments, the authentication circuitry 210 may encode the provisioning event identifier using Base64 or hexadecimal encoding, cryptographic hashing methods (e.g., hash-based message authentication code), or encryption methods (e.g., a symmetric encryption method such as advanced encryption standard (AES) or an asymmetric encryption method, such as River-Shamir-Adleman (RSA)). The encoded provisioning event identifier may be the token.

In some embodiments, if the authentication circuitry 210 determines to generate the redeemable authentication credential as a QR code, the authentication circuitry 210 may encode the provisioning event identifier into a QR code. In some embodiments, the authentication circuitry 210 may encode or format the provisioning event identifier using standardized algorithms, such as ISO/IEC 18004. The authentication circuitry 210 may perform quality assurance metrics on the generated QR code to ensure the QR code can be read even if part of the QR code is damaged.

The authentication circuitry 210 may store the redeemable authentication credential and/or corresponding provisioning event identifier in an associated memory, such as memory 204. The redeemable authentication credential may further be associated with the provisioning request within the user account. In some embodiments, the redeemable authentication credential may be stored in or associated with the provisioning event.

Returning now to FIG. 3, as shown by operation 308, the apparatus 200 includes means, such as account management circuitry 208, or the like, for generating a rule set for the provisioning event in the user account. Once the account management circuitry 208 has performed the limited account access provisioning routine, the account management circuitry 208 may further generate a rule set for provisioning event to reflect the access parameter set. As described above, the access parameter set may include one or more access parameters that describe requirements, limits, values, conditions, and/or the like in order for a designated user to be provided with limited access to the user account. Thus, the account management circuitry 208 may generate one or more rules for the provisioning event to include values of the access parameters. The rule set may include the one or more rules.

The account management circuitry 208 may generate rule that requires the redeemable authentication credential be provided. As described above, the redeemable authentication credential may encode the provisioning event identifier. The provisioning event identifier may uniquely identify the specific provisioning event and associated rules and/or parameters. Thus, a rule may require that a provided candidate redeemable authentication credential provided by a designated user via a redemption device correspond to the particular provisioning event identifier associated with the provisioning event.

Furthermore, the account management circuitry 208 may generate one or more rules based on the access parameter set. By way of continuing example and referring back to FIG. 9A, the account management circuitry 208 may have determined an irrevocable status for the revocable payment access parameter. Thus, the account management circuitry 208 may generate a rule that the authorized fund amount is not revocable. This may prohibit the provisioning user from revoking authorization for the designated user to redeem the authorized funds from the user account using a corresponding redeemable authentication credential. As another example, the account management circuitry 208 may have determined a value of 14 days for a time limit access parameter. Thus, the account management circuitry 208 may generate a rule that the credential authentication credential must be used within 14 days, or it is no longer valid. This may require the designated user to redeem the authorized fund amount with the redeemable authentication credential within 14 days from the time the redeemable authentication credential is provided. As another example, the account management circuitry 208 may further determine a “no verification required” category for the designated user verification requirement access parameter. Thus, the account management circuitry 208 may generate a rule that the designated user is not required to be authenticated in association with a redemption request. If verification was required, the account management circuitry 208 may generate a rule that the designated user is required to be authenticated prior to or during a redemption request. This would require the designated user to authenticate him/herself with the redemption device before or during the redemption request. As another example, the account management circuitry 208 may further determine a value of 12345 for the redemption location access parameter. Thus, the account management circuitry 208 may generate a rule that the credential authentication credential must be used at a location that is within the 12345-zip code.

As shown by operation 310, the apparatus 200 includes means, such as communications hardware 206, account management circuitry 208, or the like, for providing the redeemable authentication credential. The account management circuitry 208 may cause the redeemable authentication credential to be provided by the communications hardware 206. In some embodiments, the communications hardware 206 may provide the redeemable authentication credential to user device 106A, which provided the provisioning request. In some embodiments, the redeemable authentication credential may be shareable by the recipient user device (e.g., user device 106A). Upon receipt, user device 106A may provide the redeemable authentication credential to a user device, such as user device 106N, that is associated with a designated user. This may be accomplished through NFC, using Bluetooth, over Wi-Fi, through capture of the redeemable authentication credential by user device 106N (e.g., via a camera) while displayed by user device 106A, and/or the like.

Additionally, or alternatively, the communications hardware 206 may directly provide the redeemable authentication credential to user device 106N that is associated with the designated user. As described above, in some embodiments, the provisioning request may include an indication of the designated user and/or associated user device. In some embodiments, this indication may be a phone number associated with user device 106N. Thus, the account management circuitry 208 may determine whether an indication of the designated user is provided in the provisioning request and may use this information to identify the user device 106N. In some embodiments, the indication may be a username, email address, user identifier, or the like for the designated user. If the designated user also has a user account associated with apparatus 200, the account management circuitry 208 may use the indication of the designated user to identify the user account. The user device may list associated user devices of the designated user. Thus, the account management circuitry 208 may use the user account to identify user device 106N.

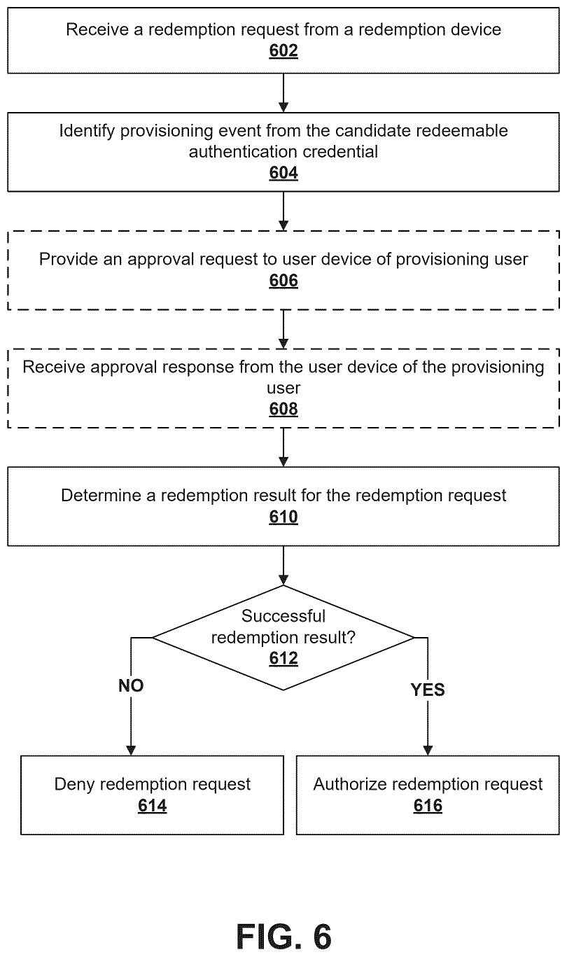

Turning next to FIG. 6, example operations are shown for handling a redemption request.

As shown by operation 602, the apparatus 200 includes means, such as communications hardware 206 or the like, for receiving a redemption request from a redemption device. Communications hardware 206 may receive the redemption request from a redemption device, such as redemption device 108A. The redemption request may be a request for limited access to a user account of the provisioning user. That is, the redemption request may be a request to redeem an authorized fund amount from the user account of the provisioning user.

The redemption request may include a candidate redeemable authentication credential. The candidate redeemable authentication credential may be provided to the redemption device 108A by user device 106N that is associated with a designated user. The user device 106N may provide the candidate redeemable authentication credential to the redemption device 108A in any suitable manner, such as through NFC, Bluetooth, Wi-Fi, through capture of the candidate redeemable authentication credential by redemption device 108A (e.g., via a camera) while displayed by user device 106N, and/or the like. For example, if the candidate redeemable authentication credential is a token, the user device 106N may provide the candidate redeemable authentication credential using NFC, Bluetooth or Wi-Fi. Alternatively, if the candidate redeemable authentication credential is a QR code, the user device 106N may display the QR code and the redemption device 108A may capture the QR code via a camera. Thus, the redemption device 108A may include the candidate redeemable authentication credential in the redemption request.

In some embodiments, prior to providing the redemption request, the designated user may log in or otherwise access an associated user account of the designated user at the redemption device 108A. For example, the redemption device 108A may be an ATM and the user may use a bank card, PIN, OTP, biometric data, or mobile application data from user device 106N to authenticate the designated user. In particular, the redemption device 108A may receive this data from the designated user and/or user device 106N and provide this data to a corresponding entity device. In some embodiments, apparatus 200 is the entity device. This may occur when the designated user has a user account maintained by apparatus 200. The entity device, such as apparatus 200 may authenticate the designated user based on the provided information. If the designated user is successfully authenticated, the redemption device 108A may provide access to the user account of the designated user. The designated user may then proceed to provide the redemption request from redemption device 108A. In some embodiments, the redemption request may further include an indication that the user has been successfully authenticated. Additionally, or alternatively, the redemption request may further include user account information of the designated user, such as a routing number, account number, and/or the like. In some embodiments, the redemption request may further include designated user information, such as a designated user's name, phone number, etc. Alternatively, the redemption request may be provided by the redemption device 108A without the designated user first needing to log in to an associated user account.

In some embodiments, the redemption request may further include a captured image of the designated user. The image may be captured by the redemption device 108A via a camera. The image may serve as proof of the identity of the designated user identity in the future and may be used to resolve disputes between the provisioning user and designated user.

As shown by operation 604, the apparatus 200 includes means, such as memory 204, authentication circuitry 210, or the like, for identifying the provisioning event from the candidate redeemable authentication credential. Upon receipt of the redemption request, the communications hardware 206 may provide the redemption request to authentication circuitry 210. Authentication circuitry 210 may be configured to analyze the candidate redeemable authentication credential to determine the provisioning event identifier, which in turn may allow the authentication circuitry 210 to identify the provisioning event. This may allow the access parameter set associated with the provisioning event to be identified and used to determine a redemption result for the redemption request.

In particular, in some embodiments, the authentication circuitry 210 may decode the candidate redeemable authentication credential to identify the encoded provisioning event identifier. In some embodiments, if the candidate redeemable authentication credential is a token, the authentication circuitry 210 may be configured to decode the token using an appropriate decoding technique. In some embodiments, the authentication circuitry 210 may be configured to determine the particular decoding technique to use based on the format of the token. In some embodiments, the token may further include a header that contains metadata and provides the encoding technique and algorithm used to encode the token. Thus, the authentication circuitry 210 may use a corresponding decoding technique to decode the token and determine the provisioning event identifier.

In some embodiments, if the candidate redeemable authentication credential is a QR code, the authentication circuitry 210 may be configured to extract the provisioning event identifier from the QR code, such as by using a mask pattern technique. The authentication circuitry 210 may further apply error correction algorithms to reconstruct any missing or corrupted portions of the extracted data. The authentication circuitry 210 may then interpret the extracted data based on the encoding mode used. Thus, the authentication circuitry 210 may obtain the provisioning event identifier from the extracted data of the QR code.

Once the authentication circuitry 210 has determined the provisioning event identifier, the authentication circuitry 210 may identify a provisioning event to which the provisioning event identifier corresponds. In particular, the authentication circuitry 210 may query an associated memory, such as memory 204, to identify a provisioning event with a provisioning event identifier that corresponds to the determine provisioning event identifier. In some embodiments, the authentication circuitry 210 may be unable to identify a corresponding provisioning event. This may indicate that the designated user failed to provide a legitimate redeemable authentication credential. Alternatively, the provided candidate redeemable authentication credential may have been corrupted or otherwise rendered inoperable. If the authentication circuitry 210 cannot identify a corresponding provisioning event, the process may proceed to operation 614, where the redemption request is denied.

If a provisioning event is identified, the authentication circuitry 210 may further identify the user account and access parameter set associated with the provisioning event. The authentication circuitry 210 may provide this information to account management circuitry 208, which in turn may use this information to determine a redemption result as described in more detail in operation 610.

Optionally, as shown by operation 606, the apparatus 200 includes means, such as communications hardware 206, account management circuitry 208, or the like, for providing an approval request to a user device of the provisioning user. In some embodiments, the account management circuitry 208 may determine that the access parameter set is indicative that an affirmative approval response must be received from user device 106A associated with the provisioning user prior to determining a redemption result. In some embodiments, this option may only be available if the access parameter set further indicates that the authorized fund amount is revocable. Thus, the account management circuitry 208 may use communications hardware 206 to provide an approval request to user device 106A. The approval request may include a request for the provisioning user to confirm or deny the designated user limited access to the user account. That is, the approval request may request the provisioning user to authorize whether the designated user may redeem the authorized fund amount from the user account.

In some embodiments, the approval request may further include redemption request and/or access parameter set data that the provisioning user may use to help make a determination on whether to approve or deny the approval request. For example, the approval request may include the image captured by the redemption device 108A that depicts the designated user. This may allow the provisioning user to visually confirm the identity of the designated user. The approval request may additionally, or alternatively, include a redemption request location, a redemption request timestamp, an authorized fund amount associated with the provisioning event, and/or the like.

The communications hardware 206 may provide the approval request to the user device 106A associated with the provisioning user. In some embodiments, the approval request may be provided as a short message service (SMS) message, an email, a push notification, and/or the like. In some embodiments, the provisioning user may be required to log in to an associated user account with a software application to access the approval request and/or provide the approval response.

Optionally, as shown by operation 608, the apparatus 200 includes means, such as communications hardware 206, account management circuitry 208, or the like, for receiving an approval response from the user device of the provisioning user. The communications hardware 206 may receive an approval response from user device 106A that is associated with the provisioning user. The approval response may be indicative of whether the provisioning user has affirmatively authorized the redemption request. For example, the user may interact with the approval request, such as by selecting “approve” or “deny” interaction elements in the approval request, to provide affirmative authorization or deny authorization. The account management circuitry 208 may determine the redemption result based on the approval response. More specifically, if the provisioning user has denied the affirmative authorization and the authorized fund amount is revocable, the account management circuitry 208 may automatically determine a failed redemption result and the process may proceed to operation 614. Alternatively, if the provisioning user has affirmatively confirmed authorization and the authorized fund amount is revocable, the account management circuitry 208 may continue to evaluate the redemption request in view of the rule set associated with the provisioning event.

As shown by operation 610, the apparatus 200 includes means, such as account management circuitry 208 or the like, for determining a redemption result for the redemption request. The account management circuitry 208 may evaluate the redemption request in view of the rule set associated with the user account of the provisioning user to determine a redemption result. A successful redemption result may indicate that the redemption request has satisfied the requirements defined in the rule set associated with the provisioning event. A failed redemption result may indicate that the redemption request has failed to satisfy one or more requirements defined in the rule set associated with the provisioning event. As described in more detail in operations 612-616, a successful redemption result may allow for the designated user to redeem or claim the authorized fund amount from the user account of the provisioning user. Alternatively, a failed redemption result may result in a denied redemption request and the designated user may not be allowed to redeem the authorized fund amount.

To determine a redemption result, the account management circuitry 208 may determine whether the designated user is authorized to redeem the authorized fund amount based on the rule set associated with the provisioning event. As described in FIG. 3, the provisioning event may have a rule set that was generated based on the access parameter set. The account management circuitry 208 may evaluate whether the redemption request satisfies each requirement of the rule set associated with the provisioning event.

By way of continuing example and with reference back to FIG. 9A, the rule set may indicate an irrevocable status for the revocable payment access parameter, a value of 14 days for a time limit access parameter, a “no verification required” category for the designated user verification requirement access parameter, and a value of 12345 for the redemption location access parameter. The account management circuitry 208 may analyze the redemption request to determine whether these requirements are satisfied.

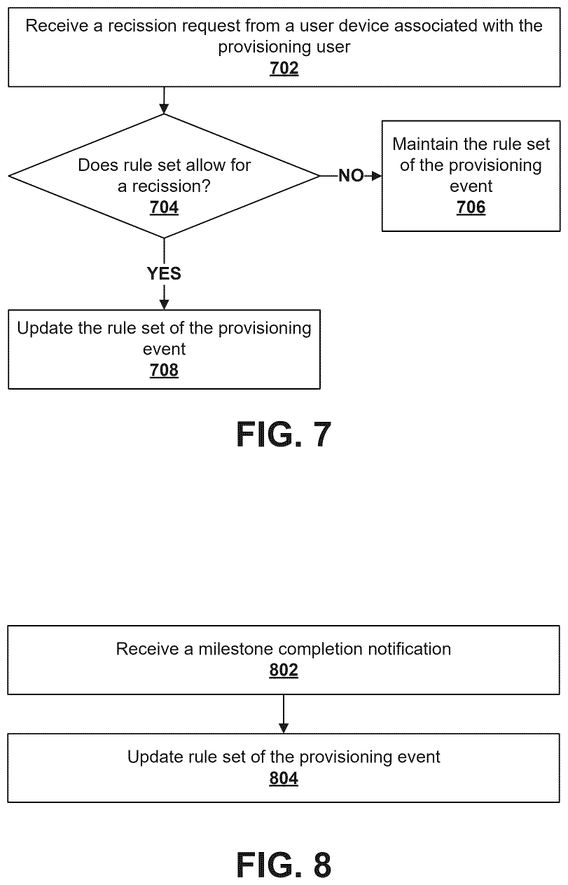

For example, because the revocable payment access parameter is associated with an irrevocable status, the account management circuitry 208 may determine this requirement is automatically satisfied. Even if the provisioning user attempted to revoke or rescind access, as further described with respect to FIG. 7, the irrevocable status would remain. Thus, the account management circuitry 208 may determine this requirement is satisfied. The account management circuitry 208 may also determine this requirement is satisfied if the revocable payment access parameter is associated with a non-revoked status. The account management circuitry 208 may also determine this requirement is satisfied for a non-revoked status. The account management circuitry 208 may determine this requirement fails to be satisfied if the revocable payment access parameter is associated with a revoked status.

As another example, the time limit access parameter is associated with a value of 14 days and thus, the account management circuitry 208 may determine whether the redemption request was received within 14 days from the time the redeemable authentication credential was generated. In some embodiments, the redemption request may have metadata that may include a timestamp indicative of the time the redemption request was generated, the location of the redemption device 108A, and/or a device identifier of the redemption device 108A. The account management circuitry 208 may use the timestamp associated with the redemption request as well as the timestamp associated with the redeemable authentication credential in the provisioning event to determine whether the redemption request was provided within 14 days of the redeemable authentication credential. If so, the account management circuitry 208 may determine this requirement is satisfied. Otherwise, the account management circuitry 208 may determine this requirement has failed to be satisfied.

As another example, because the designated user verification requirement access parameter is associated with an “no verification required” category, the account management circuitry 208 may determine this requirement is automatically satisfied. Alternatively, for a “verification required” category, the account management circuitry 208 may need to determine whether the designated user has been successfully authenticated by the redemption device 108A. As described in operation 602, in some embodiments the redemption request may include an indication that the designated user has been successfully authenticated and further, may include user account information and/or user information. The account management circuitry 208 may determine whether the redemption request is indicative that the user has been successfully authenticated. If not, the account management circuitry 208 may use communications hardware 206 to provide a notification to the redemption device 108A that the designated user must first be authenticated. In some embodiments, the designated user may authenticate him/herself by providing a driver's license or other identification item to the redemption device 108A. The redemption device 108A may capture the provided identification item and communications hardware 206 may receive the image of the captured identification item. In some embodiments, the account management circuitry 208 may determine the receipt of the image of the identification item and/or image of the designated user satisfy the verification requirement access parameter. In some embodiments, a rule of the rule set may describe the type of verification required such that the account management circuitry 208. Thus, the account management circuitry 208 may determine the specific requirements (e.g., successful designated user login, identification item image, and/or designated user image) to satisfy the designated user verification requirement access parameter.

As another example, the account management circuitry 208 may determine whether a location associated with the redemption device 108A satisfies a redemption location access parameter. In some embodiments, the redemption request may have metadata that may include a timestamp indicative of the time the redemption request was generated, the location of the redemption device 108A, and/or a device identifier of the redemption device 108A. The account management circuitry 208 may be configured to use the metadata to determine whether the location of the redemption device 108A is within the location defined by the redemption location access parameter. For example, the account management circuitry 208 may be configured to determine whether the location of redemption device 108A is within the 12345-area code. In some embodiments, the location of the redemption device 108A may be global positioning system (GPS) coordinates, a physical address, and/or the like. As another example, the account management circuitry 208 may be configured with knowledge of the location of the specific redemption device 108A. The account management circuitry 208 may use the device identifier in the redemption request to identify the redemption device 108A and then perform a lookup in an associated location database to determine the location of the redemption device 108A. If the location of the redemption device 108A is within the 12345-zip code, the account management circuitry 208 may determine this requirement is satisfied. Otherwise, the account management circuitry 208 may determine this requirement has failed to be satisfied.

As shown by operation 612, the apparatus 200 includes means, such as account management circuitry 208 or the like, for determining whether the redemption result was successful. If each requirement in the rule set was satisfied, the account management circuitry 208 may determine a successful redemption result. If one or more requirements in the rule set failed to be satisfied, the account management circuitry 208 may determine a failed redemption result. If the redemption result is not successful, the process may proceed to operation 614. If the redemption result is successful, the process may proceed to operation 616.

As shown by operation 614, the apparatus 200 includes means, such as communications hardware 206, account management circuitry 208, or the like, for denying the redemption request. The account management circuitry 208 may deny the redemption request if the redemption result is not successful and/or if the provisioning event cannot be identified from the candidate redeemable authentication credential. The account management circuitry 208 may not allow the designated user to redeem the authorized funds from the user account of the provisioning user and thereby deny any user account access to the designated user. This ensures the authorized fund amount may only be redeemed by a legitimate designated user whose redemption request satisfies the requirements defined in the rule set associated with the provisioning event. In some embodiments, the account management circuitry 208 may use communications hardware 206 to provide a redemption denial notification to the redemption device 108A. The redemption denial notification may indicate that the redemption request has been denied. In some embodiments, the redemption denial request may indicate the reason why the redemption request was denied (e.g., the candidate redeemable authentication credential was invalid, or the redemption request violated requirements of the rule set). The redemption device 108A may display the redemption denial notification to the designated user, who is made aware of the reason for the denial.

As shown by operation 616, the apparatus 200 includes means, such as communications hardware 206, account management circuitry 208, operation management circuitry 212, or the like, for authorizing redemption of the authorized fund amount. If the account management circuitry 208 determines a successful redemption result, the account management circuitry 208 may further provide authorization for the redemption of the authorized fund amount to operation management circuitry 212. In turn, the operation management circuitry 212 may provide the designated user with limited access to the user account of the provisioning user. This may allow the designated user to redeem the authorized fund amount.

In some embodiments, the operation management circuitry 212 may use communications hardware 206 to provide a transfer request to the redemption device 108A. The transfer request may allow the designated user to select a method for the authorized fund amount to be provided to the designated user. For example, the designated user may select the authorized fund amount to be deposited into a user account of the designated user. The designated user may enter his/her user account information (e.g., routing number and account number) into the transfer request. In some embodiments, this step may be optional if the user is already log into his/her user account on the redemption device 108A such that this user account information is known. As another example, the designated user may select the authorized fund amount to be dispensed from the redemption device 108A or another associated device. By way of particular example, the redemption device 108A may be an ATM and the designated user may choose to receive the authorized fund amount as cash dispensed from the ATM.

Once the user has finalized his/her selections, the communications hardware 206 may receive a transfer response from the redemption device 108A that is indicative of the user's selection. The communications hardware 206 may provide the transfer response to operation management circuitry 212. If the transfer response is indicative of a user account deposit selection, the operation management circuitry 212 may cause the authorized fund amount to be transferred from the user account associated with the provisioning user to the user account associated with the designated user. If the transfer response is indicative of a dispensing selection, the operation management circuitry 212 may cause the authorized fund amount to be dispensed by the redemption device 108A, or another associated device, and may decrement the user account of the provisioning user to reflect the payment.

Once the designated user has redeemed the authorized fund amount, the account management circuitry 208 may update the redemption status of the provisioning event to “redeemed”. Thus, the redemption status of the provisioning event may reflect that the designated user has redeemed the authorized fund amount from the user account of the provisioning user. This ensures that the designated user is only able to access the user account of the provisioning user once to redeem the authorized fund amount. As will be described further in FIG. 8, in some embodiments, the redeemable authentication credential may be used more than once to access the user account of the provisioning user when the provisioning event includes multiple payments. However, the redemption status and payment redemption status in the case of multiple payments may ensure that the authorized fund amount is only redeemable once by the designated user.

Turning next to FIG. 7, example operations are shown for handling a recission request received from a user device.

As shown by operation 702, the apparatus 200 includes means, such as communications hardware 206, account management circuitry 208, or the like, for receiving a recission request from a user device associated with the provisioning user. In some embodiments, communications hardware 206 may receive a recission request from user device 106A that is associated with the provisioning user. The recission request may be indicative of a request from the provisioning user to rescind the provided limited access to his/her user account to the designated user. That is, the recission request may be a request from the provisioning user to revoke authorization for the authorized fund amount to be redeemed by the designated user.

In some embodiments, the provisioning user may be required to log in to his/her user account using an online browser or software application, such as a mobile application, using user device 106A in order to provide the recission request. Upon successful authentication of the log in request, the provisioning user may navigate within the browser or software application to select a specific provisioning event that is currently open (e.g., the authorized fund amount has not yet been redeemed). The user may select to provide a recission request for the specific provisioning event. In some embodiments, the recission request may further include the provisioning event identifier or another indication of the selected provisioning event.

As shown by operation 704, the apparatus 200 includes means, such as account management circuitry 208, or the like, for determining whether the rule set of the provisioning event allows for a recission of authorization to transfer the authorized fund amount. As described above in connection with FIG. 3, the account management circuitry 208 may have determined an irrevocable status for the revocable payment access parameter. Thus, the account management circuitry 208 may have generate a rule that the authorized fund amount is not revocable, and the rule set associated with the provisioning event may implement and/or enforce this rule. Thus, an irrevocable status for the revocable payment access parameter may prohibit the provisioning user from revoking authorization for the designated user to redeem the authorized funds from the user account using a corresponding redeemable authentication credential. However, a revocable status for the revocable payment access parameter may allow the provisioning user to revoke or rescind authorization to transfer the authorized fund amount. Thus, account management circuitry 208 may determine whether a category of value for a revocable payment access parameter in the rule set of the provisioning event allow for a recission by the provisioning user.

If the rule set does not allow for a recission, the process may proceed to operation 706. As shown by operation 706, the apparatus 200 includes means, such as communications hardware 206, account management circuitry 208, or the like, for maintaining the rule set for the user account. If the account management circuitry 208 determines the rule set does not allow for a recission, then the account management circuitry 208 may maintain the current rule set of the provisioning event. In some embodiments, the account management circuitry 208 may cause the communications hardware 206 to provide a notification that the recission request has been denied to the user device 106A.

If the rule set allows for a recission, the process may proceed to operation 708. As shown by operation 708, the apparatus 200 includes means, such as account management circuitry 208 or the like, for updating the rule set of the provisioning event. If the account management circuitry 208 determines the rule set allows for a recission, then the account management circuitry 208 may update the current rule set of the provisioning event to reflect a revoked status for the revocable payment access parameter. Thus, should a designated user in possession of the redeemable authentication credential attempt to user the redeemable authentication credential to redeem the authorized fund amount, the account management circuitry 208 may deny the corresponding redemption request.

Finally, turning to FIG. 8, example operations are shown for handling a milestone completion notification.

As shown by operation 802, the apparatus 200 includes means, such as communications hardware 206, account management circuitry 208, or the like, for receiving a milestone completion notification. The communications hardware 206 may receive the milestone completion notification from user device 106A that is associated with the provisioning user. In some embodiments, the milestone completion notification may be indicative that the provisioning user has authorized the designated user to redeem an additional authorized fund amount associated with the provisioning event. The milestone completion notification may further indicate a selection of a particular additional authorized fund amount or particular corresponding payment.

In some embodiments, the provisioning request received in operation 302 of FIG. 3 may include one or more additional authorized fund amounts. In some embodiments, an additional authorized fund amount is associated with a particular payment of multiple payments. In particular, the provisioning user may select a multiple payment option such that he/she can create individual payments, and each payment may be associated with an additional authorized fund amount. If the user selected the multiple payment option, the user may have selected values for access parameters for each payment (e.g., an initial payment and additional payments). Thus, if there are one or more additional payments, the account management circuitry 208 may determine an access parameter set for each payment, including the initial payment and the one or more additional payments. When generating the provisioning event, the account management circuitry 208 may further generate a payment identifier for each payment. Thus, the provisioning event may include each payment of the multiple payments and further, may differentiate and disambiguate between payments. Additionally, the account management circuitry 208 may generate the rule set to include sub-rule sets. Each sub-rule set may correspond to a particular payment. The sub-rule set may include one or more rules, similar to the format of a rule set for a single payment event. In this way, the account management circuitry 208 may disambiguate differing access parameters and requirements for different payments, which correspond to different authorized fund amounts. In some embodiments, the rule set for provisioning event may reflect that the redeemable authentication credential is associated with the additional authorized fund amounts. Thus, the redeemable authentication credential may be used to redeem the additional authorized fund amounts.

In some embodiments, the rule set may require that a milestone completion notification be received for the payment corresponding to an additional authorized fund amount in order for the redeemable authentication credential to be used to redeem the additional authorized fund amounts. In particular, each payment may be associated with a payment redemption status that is indicative of whether the authorized funds for the payment have been redeemed yet. A payment redemption status may be similar to the redemption status for the provisioning event but may instead indicate whether the authorized fund amount for the particular payment has been redeemed. Furthermore, the payment redemption status may be indicative of whether the payment can be redeemed or whether the authorized fund amount can be redeemed or whether a milestone completion notification needs to be received. Thus, the account management circuitry 208 may determine the payment redemption status based on the provisioning request. For example, a payment redemption status may be “unavailable” prior to a milestone completion notification being received, “available” after a milestone completion notification is received, or “redeemed” once the additional authorized fund amount has been redeemed by the designated user. Thus, the rule set for the provisioning event may require that the payment corresponding to the additional authorized fund amount be associated with an “available” payment redemption status for the redeemable authentication credential to be used to redeem said additional authorized fund amount.

In some embodiments, the provisioning user may be required to log in to his/her user account using an online browser or software application, such as a mobile application, using user device 106A in order to provide the milestone completion notification. Upon successful authentication of the log in request, the provisioning user may navigate within the browser or software application to select a specific provisioning event that is currently open (e.g., the authorized fund amount has not yet been redeemed). Additionally, the provisioning user may select an additional authorized fund amount within the provisioning event that he/she would like to authorize. In some embodiments, the milestone completion notification may further include the provisioning event identifier and an indication of the additional authorized fund amount for the provisioning event. For example, the provisioning user may provide a milestone completion notification in response to a designated user completing a particular service that may be a part of a larger, multi-part service. The provisioning user may thus provide a provisioning request that breaks up a larger authorized fund amount into smaller authorized fund amounts. In order for a designated user to access additional authorized fund amounts, the provisioning user must provide a milestone completion notification to unlock the additional authorized fund amount.

Turning to FIG. 9B, a GUI is provided that illustrates another example of a provisioning request. In particular, FIG. 9B illustrates a provisioning request that includes an additional authorized fund amount. As shown in FIG. 9B, the user may input a value of $2000.00 for the fund total access parameter field 921 within the provisioning request. Additionally, the provisioning request the user may select only a multiple payment option for the multiple payment request parameter 922. Thus, this enables the user to add second payment 940 in addition to the initial payment 930. Additionally, the user may interact with the add payment interaction element 951 to add more additional authorized funds (e.g., third payment, fourth payment, etc.). Each payment may be associated with its own values for access parameter fields. That is, the provisioning user may customize the values for an access parameter field for each additional authorized fund amount.

For example, the initial payment 930 may include user input values and/or selections for access parameter fields 931-936. The provisioning user may select that this payment is associated with an authorized fund amount of $500 for the authorized fund amount parameter 931, select that the payment is not revocable for the revocable access parameter field 932, select that the payment is immediately redeemable/available to the designated user for the availability access parameter field 933, input a value of 14 days for the time limit access parameter field 934, select that the designated user is not required for the designated user verification access parameter field 935, and input no limits for a redemption location access parameter field 936. The second payment 940 may include user input values and/or selections for access parameter fields 941-946. The provisioning user may select that this second payment is associated with an authorized fund amount of $1500 for the authorized fund amount parameter 941, select that the payment is revocable for the revocable access parameter field 942, select that the payment is redeemable/available to the designated user upon completion of a milestone event for the availability access parameter field 943, input a value of 14 days for the time limit access parameter field 944, select that the designated user is not required for the designated user verification access parameter field 945, and input no limits for a redemption location access parameter field 946. The communications hardware 206 may receive the provisioning request from the user device 106A in response to the user interacting with the submit interaction element 952.

As shown by operation 804, the apparatus 200 includes means, such as account management circuitry 208 or the like, for updating the rule set of the provisioning event. In response to receiving the milestone completion notification, the communications hardware 206 may provide the milestone completion notification to the account management circuitry 208. Account management circuitry 208 may identify the additional authorized fund amount designated by the milestone completion notification and may update the requirements associated with the provisioning event. In particular, the account management circuitry 208 may update the access status for the corresponding additional authorized fund amount to an “unlocked” access status. Once an additional authorized fund amount is set to an “unlocked” status, the designated user may be authorized to redeem the additional authorized fund amount. Thus, if a redemption request were received from the redemption device and included a candidate redeemable authentication credential that corresponded to the provisioning event, the designated user may be authorized to redeem the additional authorized fund amount. If multiple authorized fund amounts are currently unclaimed by the designated user, the designated user may be authorized to redeem the full amount of the sum of each additional authorized fund amount associated with an “unlocked” status as well as an unclaimed initial authorized fund amount.

FIGS. 3-8 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices that perform the specified functions, or combinations of special purpose hardware and software instructions.

### Conclusion

As described above, example embodiments provide methods and apparatuses that enable improved P2P transfers between users. By generating a provisioning event identifier that is encoded within a redeemable authentication credential, example embodiments remove the technological barrier imposed by traditional P2P platforms. Instead, the designated user may use the redeemable authentication credential at a redeemable device, which may provide the designated user with limited access to the user account of the provisioning user to redeem an authorized fund amount.

Additionally, in some embodiments, the redeemable authentication credential is provided to the provisioning user, who must provide the redeemable authentication credential to the designated user using short-distance communication methods. This may avoid the security vulnerabilities associated with traditional P2P platforms. Furthermore, the provisioning request may be authenticated using a passkey of the user device of the provisioning user. The use of the passkey provides for enhanced security around the P2P transaction by verifying the provisioning user identity before allowing the designated user to redeem any funds from the user account of the provisioning user.

Furthermore, example embodiments provide provisioning users and designated users with elevated control over the P2P transaction. In particular, the provisioning user may specify his/her desired criteria within the provisioning request. In some embodiments, the designated user may be provided with an approval request, which gives the designated user an opportunity to approve, deny, or modify the parameters imposed by the provisioning user. Thus, example embodiments provide for a flexible and robust P2P system for transacting between parties.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for provisioning limited user account access, the method comprising:
receiving, by communications hardware, a provisioning request from a user device associated with a provisioning user, wherein the provisioning request comprises an authorized fund amount;
in response to receipt of the provisioning request, performing, by account management circuitry, a limited account access provisioning routine by:
determining, based on the provisioning request, an access parameter set for a provisioning event associated with a user account associated with the provisioning user, and
causing generation of a redeemable authentication credential;
generating, by the account management circuitry, a rule set for the provisioning event to reflect the access parameter set, wherein the rule set allows for redemption of the authorized fund amount from the user account using the redeemable authentication credential; and
providing, by the communications hardware, the redeemable authentication credential to the user device.

2. The method of claim 1, further comprising:
generating, by authentication circuitry, a passkey challenge for the user device;
providing, by the communications hardware, the passkey challenge for the user device;
receiving, by the communications hardware, a passkey response comprising a signed passkey challenge from the user device; and
authenticating, by the authentication circuitry, the signed passkey challenge, wherein the limited account access provisioning routine is only performed in an instance in which the signed passkey challenge is successfully authenticated.

3. The method of claim 1, further comprising:
receiving, by the communications hardware, a redemption request comprising a candidate redeemable authentication credential from a redemption device;
identifying, by authentication circuitry, the provisioning event associated with the candidate redeemable authentication credential;
determining, by the account management circuitry and based on the rule set, a redemption result for the redemption request; and
in response to determining a successful redemption result, authorizing, by the account management circuitry, the redemption request, wherein authorization of the redemption request allows for redemption of the authorized fund amount from the user account by the redemption device.

4. The method of claim 3, further comprising:
in response to receipt of the redemption request, providing, by the communications hardware, an approval request to the user device; and
receiving, by the communications hardware, an approval response from the user device, wherein (a) the approval response is indicative of whether the provisioning user authorizes the redemption request and (b) determining the redemption result is based on the approval response.

5. The method of claim 3, further comprising causing, by operation management circuitry, the authorized fund amount to be transferred from the user account associated with the provisioning user to a user account associated with a designated user.

6. The method of claim 3, further comprising causing, by operation management circuitry, the authorized fund amount to be dispensed by the redemption device.

7. The method of claim 3, wherein the redemption device is an automated teller machine.

8. The method of claim 1, further comprising:
receiving, by the communications hardware, a recission request from the user device;
determining, by the account management circuitry, whether the rule set allows for a recission of authorization to transfer the authorized fund amount;
in an instance in which the rule set allows for the recission, updating, by the account management circuitry, the rule set of the provisioning event, wherein the updated rule set does not allow for redemption of the authorized fund amount from the user account using the redeemable authentication credential; and
in an instance in which the rule set does not allow for the recission, maintaining, by the account management circuitry, the rule set of the provisioning event.

9. The method of claim 1, wherein the provisioning request comprises an additional authorized fund amount,
wherein the rule set further reflects that (a) the redeemable authentication credential is associated with the additional authorized fund amount and (b) the redeemable authentication credential cannot be used to redeem the additional authorized fund amount until a milestone completion notification is received.

10. The method of claim 9, further comprising:
receiving, by the communications hardware, a milestone completion notification from the user device associated with the provisioning user; and
in response to receiving the milestone completion notification, updating, by the account management circuitry, the rule set of the provisioning event to reflect that the redeemable authentication credential can be used to redeem the additional authorized fund amount.

11. The method of claim 1, wherein the provisioning request comprises one or more of (a) a time limit for which the redeemable authentication credential is valid, (b) an indication of whether the redeemable authentication credential is revocable or irrevocable, (c) one or more authorized redemption locations or redemption devices, and (d) an indication of a designated user.

12. The method of claim 1, wherein the redeemable authentication credential is a QR code or a token.

13. An apparatus for provisioning limited user account access, the apparatus comprising:
communications hardware configured to receive a provisioning request from a user device associated with a provisioning user, wherein the provisioning request comprises an authorized fund amount; and
account management circuitry configured to:
in response to receipt of the provisioning request, perform a limited account access provisioning routine by:
determining, based on the provisioning request, an access parameter set for a provisioning event associated with a user account associated with the provisioning user; and
causing generation of a redeemable authentication credential, and
generate a rule set for the provisioning event to reflect the access parameter set, wherein the rule set allows for redemption of the authorized fund amount from the user account using the redeemable authentication credential,
wherein the communications hardware is further configured to provide the redeemable authentication credential to the user device.

14. The apparatus of claim 13, further comprising authentication circuitry configured to generate a passkey challenge for the user device,
wherein the communications hardware is further configured to:
provide the passkey challenge for the user device, and
receive a passkey response comprising a signed passkey challenge from the user device,
wherein the authentication circuitry is further configured to authenticate the signed passkey challenge, wherein the limited account access provisioning routine is only performed in an instance in which the signed passkey challenge is successfully authenticated.

15. The apparatus of claim 13, wherein the communications circuitry is further configured to receive a redemption request comprising a candidate redeemable authentication credential from a redemption device,
wherein the apparatus further comprises authentication circuitry configured to identify the provisioning event associated with the candidate redeemable authentication credential,
wherein the account management circuitry is further configured to:
determine, based on the rule set, a redemption result for the redemption request; and
in response to determining a successful redemption result, authorize the redemption request, wherein authorization of the redemption request allows for redemption of the authorized fund amount from the user account by the redemption device.

16. The apparatus of claim 15, wherein the communications hardware is further configured to:
in response to receipt of the redemption request, provide an approval request to the user device; and
receive an approval response from the user device, wherein (a) the approval response is indicative of whether the provisioning user authorizes the redemption request and (b) determining the redemption result is based on the approval response.

17. The apparatus of claim 15, wherein the apparatus further comprises operation management circuitry configured to cause the authorized fund amount to be transferred from the user account associated with the provisioning user to a user account associated with a designated user.

18. The apparatus of claim 15, wherein the apparatus further comprises operation management circuitry configured to cause the authorized fund amount to be dispensed by the redemption device.

19. The apparatus of claim 15, wherein the redemption device is an automated teller machine.

20. A computer program product for provisioning limited user account access, the computer program product comprising a non-transitory computer-readable storage medium storing instructions that, when executed by an apparatus, cause the apparatus to:
receive a provisioning request from a user device associated with a provisioning user, wherein the provisioning request comprises an authorized fund amount;
in response to receipt of the provisioning request, perform a limited account access provisioning routine by:
determining, based on the provisioning request, an access parameter set for a provisioning event associated with a user account associated with the provisioning user, and
causing generation of a redeemable authentication credential;
generate a rule set for the provisioning event to reflect the access parameter set, wherein the rule set allows for redemption of the authorized fund amount from the user account using the redeemable authentication credential; and
provide the redeemable authentication credential to the user device.
